(19) United States
(12) Patent Application Publication
(10) Pub. No.: US 2017/0155243 A1
(43) Pub. Date: Jun. 1, 2017

(54) ELECTROSTATIC DISCHARGE (ESD) CLAMP ON-TIME CONTROL

(71) Applicant: BROADCOM CORPORATION, Irvine, CA (US)

(72) Inventors: Junhua TAN, Irvine, CA (US); Hui PAN, Coto De Caza, CA (US); Evelyn WANG, Irvine, CA (US); Abhijat GOYAL, Chandler, AZ (US); Kent OERTLE, Phoenix, AZ (US)

(73) Assignee: BROADCOM CORPORATION, Irvine, CA (US)

(21) Appl. No.: 14/954,164

(22) Filed: Nov. 30, 2015

(51) Int. Cl. H02H 9/04

(52) U.S. Cl. CPC H02H 9/04

(57) ABSTRACT

A device for providing electrostatic discharge (ESD) protection includes circuitry configured to detect an occurrence of an ESD event at one or more voltage rails. An ESD clamp is activated via a clamp triggering path to provide a discharge path for an ESD current. A gate voltage of the ESD clamp is maintained greater than a predetermined threshold via a holding path in parallel with the clamp triggering path.

### BACKGROUND

Technical Field

The present disclosure relates to electronic circuits, specifically a device and method for controlling clamp operation in a electrostatic discharge (ESD) protection circuit.

Description of the Related Art

ESD protection is used in semiconductor devices, such as integrated circuits (ICs), dies, chips, SoC (System on Chip), and the like. Semiconductor devices have a conductive interface, such as metal pins or solder balls, for signal input/output and power supplies. However, the conductive interface also provides potential electrical paths which conduct external charge associated with an ESD event into internal components of the semiconductor devices. To protect the internal components from damage due to the ESD, the semiconductor devices are equipped with ESD protection circuits that include rail clamps between power rails of the semiconductor devices.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary schematic diagram of a related art snapback-based cable electrostatic discharge (CESD) protection circuit, according to certain embodiments;

FIG. 2 is an exemplary schematic diagram of a related art active clamp CESD protection circuit, according to certain embodiments;

FIG. 3 is an exemplary schematic diagram of a related art rail clamp ESD protection circuit with dynamic time constant adjustment, according to certain embodiments;

FIG. 4 is an exemplary overview diagram of a multi-path, multi-time constant ESD protection circuit, according to certain embodiments;

FIG. 5 is an exemplary schematic diagram of a multi-path, multi-time constant ESD protection circuit, according to certain embodiments;

FIG. 6 is an exemplary flowchart of an ESD clamp control process, according to certain embodiments;

FIG. 7 is an exemplary graph illustrating triggering path and holding path operations of an ESD clamp circuit, according to certain embodiments; and

FIG. 8 is an exemplary graph illustrating operating voltages of ESD clamp control circuits, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

In an exemplary embodiment, a device includes circuitry configured to detect an occurrence of an electrostatic discharge (ESD) event at one or more voltage rails, activate an ESD clamp via a clamp triggering path to provide a discharge path for an ESD current, and maintain a gate voltage of the ESD clamp greater than a predetermined threshold via a holding path in parallel with the clamp triggering path.

In another exemplary embodiment, a method includes detecting an occurrence of an electrostatic discharge (ESD) event at one or more voltage rails; activating an ESD clamp via a clamp triggering path to provide a discharge path for an ESD current; and maintaining a gate voltage of the ESD clamp greater than a predetermined threshold via a holding path in parallel with the clamp triggering path.

In another exemplary embodiment, a device includes circuitry configured to decouple a triggering signal from an on-time control signal for an ESD clamp response to an occurrence of an ESD event, and passively control an on-time of the ESD clamp independent of a supply rail voltage.

Aspects of the present disclosure are directed to a device and method for providing electrostatic discharge (ESD) protection in response to ESD events via multiple parallel circuit paths having multiple time constants. In some implementations, the ESD events can include sudden, unexpected voltage transients that occur across voltage rails of a semiconductor device, such as an integrated circuit (IC) due to a buildup of static charge. For example, in cable ESD (CESD) applications, an ETHERNET cable can have a lot of static charge so when the cable is plugged into an ETHERNET port of a computer, modem, and the like, the static charge produces the voltage transient across the voltage rails.

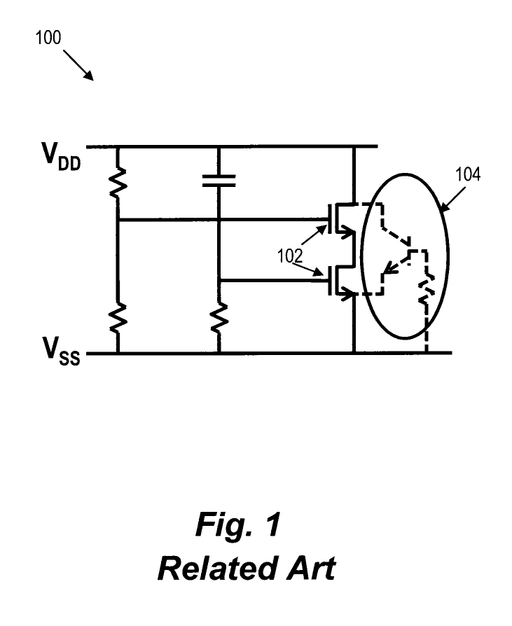

FIG. 1 is an exemplary schematic diagram of a related art snapback-based electrostatic discharge (ESD) protection circuit 100 that can be implemented in cable ESD (CEDS) applications, according to certain embodiments. In some implementations, the ESD protection circuit 100 provides a current path to ground in response to a sudden voltage surge caused by contact between two electrically charged objects, such as when an ETHERNET cable is plugged into a connection port of a switch or router. The ESD protection circuit 100 includes stacked metal-oxide-semiconductor field-effect transistors (MOSFETs) 102 that are connected in series between voltage rails V_{DD} and V_{SS} of a semiconductor device to provide overvoltage (OV) protection. In one implementation, the supply voltage V_{DD} is 3.3 volts (V) and each of the MOSFETs 102 are rated for 1.8 volts, so the MOSFETs 102 are stacked to be able to accommodate 3.3 V. In addition, the snapback transistor 104 can be a bipolar junction transistor (BJT) that includes a mechanism in which avalanche breakdown provides a base current greater than a threshold to turn on the snapback transistor 104 to provide a current path to ground V_{SS} for the current produced by the ESD voltage transient. For a parasitic NPN snapback transistor 104, during an ESD event, a collector voltage becomes so high that the snapback transistor 104 reversely turns on and produces a current from collector to base. The snapback transistor 104 enters the avalanche mode when the current is produced, which allows the snapback transistor 104 to absorb the current generated by the ESD event. However, increasing the number of stacked MOSFETs 102 decreases the efficiency of the snapback transistor 104 by increasing a total resistance of the MOSFETs 102. In addition, the increased resistance of the MOSFETs results in an increased trigger voltage to achieve snapback conditions in the snapback transistor 104.

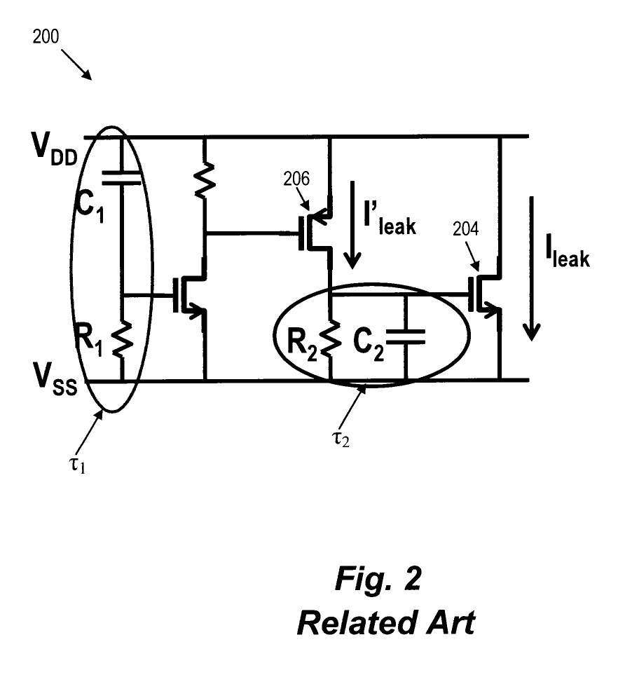

FIG. 2 is an exemplary schematic diagram of a related art active clamp ESD protection circuit 200, according to certain embodiments. In some implementations, the ESD protection circuit 200 includes at least one laterally diffused MOSFET (LDMOS), such as an active clamp device 204 that can be implemented as a NMOS transistor. When an ESD event occurs at a semiconductor device, the supply voltage V_{DD} increases and passes through a high pass filter including capacitor C₁ and resistor R₁, which pulls a gate of the active clamp device 204 high, and the active clamp device 204 absorbs current generated by the ESD event through the drain of the NMOS transistor. A first time constant, τ₁, of the high pass filter has a value of R₁C₁. In addition, a size of the active clamp device 204 can be increased to accommodate increased ESD currents, which results in a leakage current Iₗₑₐₖ at the active clamp device 204 and an additional leakage current Iₗₑₐₖ at a second stage clamping device 206. The additional leakage current Iₗₑₐₖ′, passes through resistor R₂, which results in a voltage at the gate of the active clamping device 204 equal to Iₗₑₐₖ′R₂. In addition, a magnitude of the leakage current Iₗₑₐₖ at the active clamp device 204 is based on the size of the active clamp device, and even small values of Iₗₑₐₖ′R₂ can produce larger values of the leakage current Iₗₑₐₖ.

In addition, an amount of time that the active clamp device 204 remains activated (on-time) corresponds to a second time constant, τ₂, which has a value of R₂C₂ and is greater than the value of the first time constant, τ₁. When an ESD event occurs, the gate of the active clamp device 204 goes high, and then discharges at a rate that is based on τ₂. In some implementations, the value of τ₂ is designed to provide an on-time for the active clamp device 204 that is greater than a time length of a worst-case ESD event. For example, an ESD event for a cable that is two hundred meters (m) in length may have a time length of two microseconds (μs). Therefore, the value of τ₂ may be designed to provide an on-time of greater than two microseconds. However, increasing the design values of R₂ and C₂ to achieve a desired value of τ₂ can have one or more drawbacks. For example, increasing the value of R₂ produces an increased value of Iₗₑₐₖ′R₂, which can cause excessive leakage currents of up to one amp through the active clamp device 204 during ESD events. The increased leakage current Iₗₑₐₖ caused by the increased value of R₂ can also result in increased power consumption by the ESD protection circuit 200. In addition, increasing the capacitance value of C₂ increases the area of the ESD protection circuit 200 and also degrades turn-on speed of the active clamp device 204. For example, the capacitor C₂ is charged in order to activate the gate of the active clamp device 204 during an ESD event. Increasing the capacitance value of capacitor C₂ increases an amount of time it takes to charge the gate active clamp device 204, which decreases the turn-on speed of the active clamp device 204.

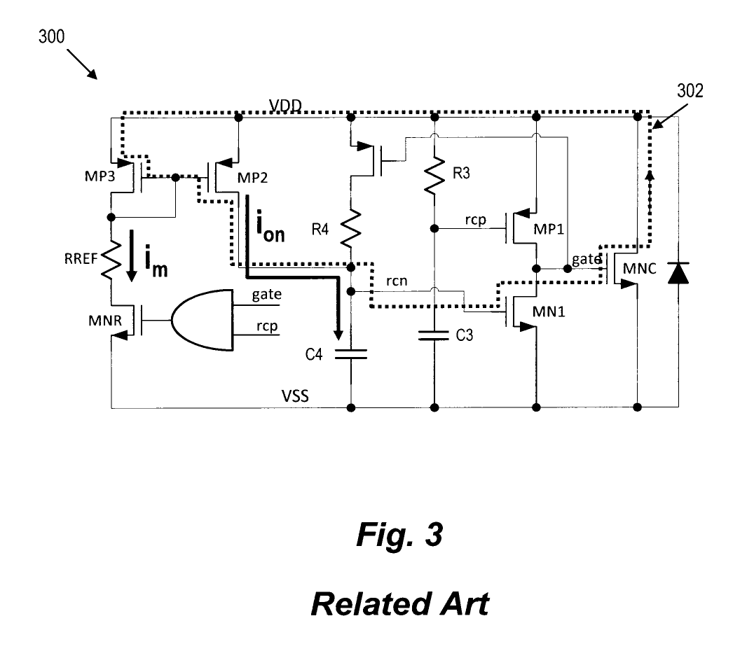

FIG. 3 is an exemplary schematic diagram of a related art rail clamp ESD protection circuit 300 with dynamic time constant adjustment, according to certain embodiments. The ESD protection circuit 300 is designed to reduce the tradeoffs associated with leakage current and clamp on-time discussed previously with respect to FIG. 2 and uses a positive feedback loop from an active current iₒₙ to control the on-time of clamping device MNC, which is a NMOS transistor. When an ESD event occurs on the V_{DD} rail, rcp node is low, and PMOS transistor MP1 switches on to drive the gate node high. The transistor MP1 is driven by a trigger time constant associated with resistor R₃ and capacitor C₃. When the gate node is driven high, the clamping device MNC switches on and dissipates the ESD event by providing a path for the current generated by the ESD event to the ground rail V_{SS}.

In addition, the ESD protection circuit 300 includes a current mirror iₘ that is engaged when transistor MNR is turned on by an AND gate that has the gate and rcp nodes as inputs. For example, the transistor MNR is turned on when the gate and rcp nodes are both high. The current mirror iₘ is based on the supply voltage V_{DD}, V_{GS} of the MP3 diode-connected transistor, and the reference resistor value R_{REF} according to the equation,

$${i}_{m} = \frac{{V}_{DD} - {V}_{GS}}{{R}_{REF}} .$$

The current mirror iₘ in turn controls the value of iₒₙ because the gates of the MP3 diode-connected transistor and the MP2 transistor are connected. In addition, the active current iₒₙ controls the value of the gate voltage of the MN1 transistor, which is driven by a trigger time constant from resistor R₄ and capacitor C₄. The MN1 transistor acts as an inverter such that as the rcn node at the gate of the MN1 transistor is driven high by the current iₒₙ, the gate voltage of the clamping device MNC is pulled low. In some implementations, the on-time of the clamping device MNC is based on the current iₒₙ. For example, smaller values of iₒₙ produce a longer on-time for the clamping device MNC that larger values of iₒₙ as the gate of the transistor MN1 is charged a slower rate, which results in the gate of the clamping device MNC being pulled low at a slower rate.

However, in some implementations, the ESD protection circuit 300 operates with a positive feedback loop 302 that can result in a deadlock condition for the clamping device MNC. When the clamping device MNC is activated in response to an ESD event, the supply voltage V_{DD} may be reduced to a value that is less than a minimum voltage that may be required to turn on the transistor MP3, which may result in a current mirror iₘ of zero. For example, if the minimum voltage to turn on transistor MP3 is 600 millivolts (mV), and V_{DD} is less than 600 mV, then the current mirror iₘ does not turn on, and the current iₒₙ is zero. If iₒₙ is zero, then the voltage at the rcn node remains low, and the gate node voltage remains high, which means that the clamping device MNC remains on in a deadlock condition.

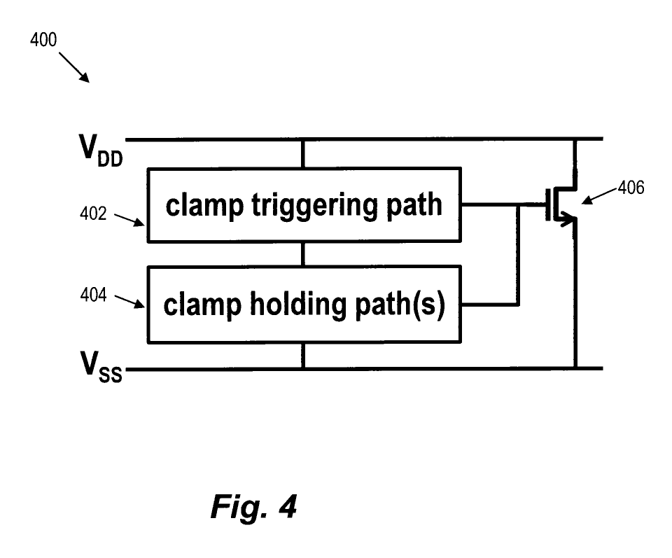

FIG. 4 is an exemplary overview diagram of a multi-path, multi-time constant ESD protection circuit 400, according to certain embodiments. The ESD protection circuit 400 is connected between voltage rails VDD and VSS of a semiconductor device, such as an integrated circuit (IC), SoC (System on Chip), and the like. In one implementation, the ESD protection circuit 400 is connected between voltages rails of a gigabit ETHERNET PHY (GPHY) installed in a switch and/or router. In some implementations, the ESD protection circuit 400 provides passive on-time control of a clamping device 406 that increases the on-time of the clamping device 406 while also reducing current leakage without a feedback loop so that the deadlock condition experienced by the ESD protection circuit 300 does not occur. The clamping device 406 is a NMOS transistor that connects the supply voltage V_{DD} and ground voltage V_{SS} rails to provide a path to absorb current produced by ESD events.

The ESD protection circuit 400 includes two or more parallel paths having two or more time constants that control the on-time of the clamping device 406. For example, the ESD protection circuit 400 includes a clamp triggering path 402 that pulls the gate of the clamping device 406 high to activate the clamp during an ESD event and at least one clamp holding path 404 in parallel with the clamp triggering path 402 to charge the gate of the clamping device 406 in order to overcome the current discharged from the triggering path 402. In some implementations, the time constants of the at least one holding path 404 are greater than the time constant of the triggering path 402 so that the holding path 404 remains activated for a longer period of time than the triggering path 402 and extends the on-time of the clamping device 406. In addition, a current produced by the at least one holding path 404 is greater than an amount of current discharged by the triggering path 402.

In some implementations, a response of the triggering path 402 to an ESD event occurrence is faster and larger than the response by the at least one holding path 404. Likewise, the response of the at least one holding path 404 to the ESD event is slower and smaller than the triggering path 402. According to certain embodiments, strength of a response by the transistors of the ESD protection circuit 400 is directly proportional to a size of the transistors (e.g., width/length) and corresponds to a measure of a speed with which the transistors turn on in response to a triggering event. In addition, the strength of response can be based on an amount of current between the source and drain when the transistor is turned on. For example, a transistor with a larger width/length (W/L) measurement has a larger turn-on response that a transistor with a smaller W/L measurement.

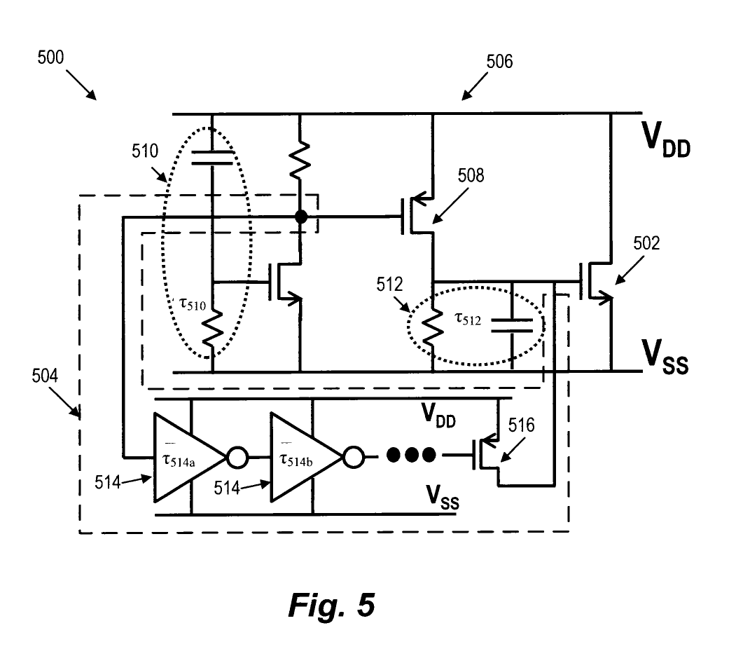

FIG. 5 is an exemplary schematic diagram of a multi-path, multi-time constant ESD protection circuit 500, according to certain embodiments. The ESD protection circuit 500 is one implementation of the ESD protection circuit 400 described previously with respect to FIG. 4. For example, the ESD protection circuit 500 includes two or more parallel paths having two or more time constants that control the on-time of clamping device 502, which is a NMOS transistor that connects the supply voltage V_{DD} and ground voltage V_{SS} rails to provide a path to absorb current produced by ESD events. The ESD protection circuit 500 includes a clamp triggering path 506 that pulls the gate of the clamping device 502 high to activate the clamp during an ESD event and at least one clamp holding path 504 in parallel with the clamp triggering path 506 to charge the gate of the clamping device 502 in order to overcome the current discharged from the triggering path 506.

In some implementations, time constants associated with the clamp triggering path 506 and the holding path 504 are designed so that the clamping device 502 remains active for a period of time that is greater than a time length of a worst-case ESD event associated with the device to which the ESD protection circuit 500 is protected. For example, if the ESD protection circuit 500 is being used to provide CESD protection to an ETHERNET PHY, the time constants of the of the holding path 504 and/or clamp triggering path 506 can be designed to maintain the clamping device 502 in an on state for an amount of time that is at least as long as an ESD event that may occur when a charged cable is inserted into an ETHERNET port of a switch or router. In one implementation, the worst-case ESD event length is 2.0 μs so the time constants of the holding path 504 are designed so that the total on-time of the clamping device 502 is greater than or equal to 2.0 μs.

In some implementations, the clamp triggering path 506 includes a high pass filter 510 that includes a resistor and capacitor having a time constant, τ₅₁₀. The high pass filter 510 filters out voltage transients events that are slower than a predetermined threshold so that the ESD protection circuit 500 does not activate the clamping device 502 in response to a non-ESD event. The time constant τ₅₁₀ indicates a minimum rate of change of the supply voltage V_{DD} for the clamping device 502 to be activated. For example, when a device to which the ESD protection circuit 500 is connected is powered on, a supply voltage V_{DD} is ramped up at a rate that may be slower than a voltage transient caused by an ESD event. Therefore, the high pass filter 510 can filter out the slower voltage transient caused by device power up so that an inadvertent activation of the clamping device 502 does not occur.

The clamp triggering path 506 also includes a first PMOS transistor 508 with source connected to the supply voltage V_{DD} and drain connected to the gate of the clamping device 502. When an ESD event occurs, the first PMOS transistor 508 switches on and produces a clamp triggering path signal to drive the gate of the clamping device 502 high, which triggers the clamping device 502 to turn on. The response of the clamping device 502 to the ESD event is based on a size of the first PMOS transistor 508. For example, increasing a W/L ratio of the first PMOS transistor 508 increases the speed and strength of response of the clamping device 502 to the ESD event. The clamp triggering path 506 also has a gate discharge path 512 that includes a resistor and capacitor in parallel with a time constant of τ₅₁₂. For example, when the voltage at the gate of the clamping device 502 is driven high and the clamping device 502 is activated, current is drained from the gate of the clamping device 502 to ground VSS via the gate discharge path 512 until the gate voltage is less than a threshold to maintain the clamping device 502 turned on. In certain embodiments, the time constant τ₅₁₂ defines how long the clamping device 502 remains on after being triggered by the first PMOS transistor 508 in response to the ESD event.

In some implementations, the at least one holding path 504 is connected to the ESD protection circuit 500 in parallel with the clamp triggering path 506. The holding path 504 produces a holding path signal that charges the gate of the clamping device 502 in order to overcome the current discharged from the triggering path 402. The holding path 504 includes one or more time constant components 514 such as PMOS-RC and/or NMOS-RC inverters that extend the on time of the holding path 504 to an ESD event. For example, the time constant components 514 increase an amount of time between the occurrence of the ESD event and deactivation of the holding path 404 such that an amount of time between the occurrence of the ESD event and deactivation of the clamp triggering path 402 is less than an amount of time between the occurrence of the ESD event and deactivation of the holding path 404. The ESD protection circuit 500 has two series-connected time constant components 514 having time constants τ₅₁₄ₐ and τ_{514b}. In some implementations, a sum of the time constants associated with the holding path 504, τ₅₁₄ₐ and τ_{514b}, is greater than a sum of the time constants associated with the clamp triggering path 506, τ₅₁₂ and τ₅₁₀. Therefore, the holding path 504 stays activated even after the triggering path 506 is deactivated. The holding path 504 charges the gate of the clamping device 502 for a longer amount of time than the clamp triggering path 506 so that the clamping device 502 remains active and provides a path to ground for the current generated by the voltage transient of the ESD event at the voltage rails V_{DD} and V_{SS}.

In some implementations, the holding path 504 can include a second PMOS transistor 516 that shares common source and drain connection points with the first PMOS transistor 508 of the clamp triggering path 506. For example, the source of the second PMOS transistor 516 is connected to the supply voltage V_{DD} and the drain is connected to the gate of the clamping device 502. Therefore, the signal produced by the holding path 504 can charge the gate of the clamping device 502 in order to overcome the current discharged from the gate discharge path 512 so that a total on-time of the clamping device 502 can be increased. In addition, the W/L ratio of the second PMOS transistor 516 may be less than the W/L ratio of the first PMOS transistor 508. In one implementation, the W/L ratio of the second PMOS transistor 516 is approximately 5% to 10% the W/L ratio of the first PMOS transistor 508. According to certain embodiments, the W/L ratio of the transistors is directly proportional to an amount of leakage current generated by the transistors such that transistors with larger W/L ratios generate larger amounts of leakage current than smaller transistors. By designing the second PMOS transistor 516 to have a size that is small as compared to the first PMOS transistor 508, the holding path 504 can increase the on-time of the clamping device 502 without generating leakage currents that affect the total leakage current of the ESD protection circuit 500. For example, if the second PMOS transistor 516 has a W/L ratio that is 5% of the W/L ratio of the first PMOS transistor 508, the amount of leakage current generated by the holding path 504 is approximately 5% of the amount of leakage current generated by the clamp triggering path 506.

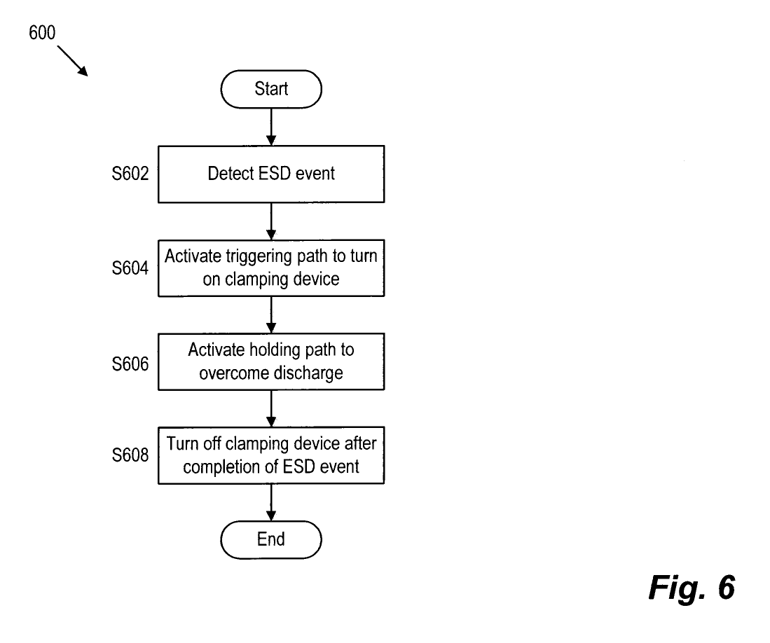

FIG. 6 is an exemplary flowchart of an ESD clamp control process 600, according to certain embodiments. The present disclosure describes the ESD clamp control process 600 with respect to the ESD protection circuit 500 but can also be implemented on any other type of multi-path, multi-time constant ESD protection circuit that uses passive on-time control via parallel, independent triggering and holding paths to maintain a clamping device, such as the clamping device 502, in an on state to absorb current generated by an ESD event. By decoupling the clamp triggering path 506 from the holding path 504, the ESD protection circuit 500 can provide a fast, strong response to ESD events that lasts for at least as long as a worst-case ESD event without any drawbacks associated with an excessive leakage current.

At step S602, the ESD protection circuit 500 detects an occurrence of an ESD event based on speed of a voltage transient between the voltage rails V_{DD} and V_{SS} of the semiconductor device. The clamp triggering path 506 includes a high pass filter 510 that includes a resistor and capacitor having a time constant, τ₅₁₀. The high pass filter 510 filters out voltage transient events that are slower than a predetermined threshold so that the ESD protection circuit 500 so that the ESD protection circuit 500 does not activate the clamping device 502 in response to a non-ESD event. The time constant τ₅₁₀ indicates a minimum rate of change of the supply voltage V_{DD} for the clamping device 502 to be activated. For example, when a device to which the ESD protection circuit 500 is connected is powered on, a supply voltage V_{DD} is ramped up at a rate that may be slower than a voltage transient caused by an ESD event. Therefore, the high pass filter 510 can filter out the slower voltage transient caused by device power up so that an inadvertent activation of the clamping device 502 does not occur.

At step S604, the clamp triggering path 506 is activated by the clamp triggering path signal to turn on the clamping device 502. The clamp triggering path 506 can include a first PMOS transistor 508 with source connected to the supply voltage V_{DD} and drain connected to the gate of the clamping device 502. When an ESD event occurs, the first PMOS transistor 508 switches on and produces the clamp triggering path signal to drive the gate of the clamping device 502 high, which triggers the clamping device 502 to turn on. The response of the clamp device 502 to the ESD event is based on a size of the first PMOS transistor 508. For example, increasing a W/L ratio of the first PMOS transistor 508 increases the speed and strength of response of the clamping device 502 to the ESD event. The clamp triggering path 506 also has a gate discharge path 512 that includes a resistor and capacitor in parallel with a time constant of τ₅₁₂. For example, when the voltage at the gate of the clamping device 502 is driven high and the clamping device 502 is activated, current is drained from the gate of the clamping device 502 to ground VSS via the gate discharge path 512 until the gate voltage is less than a threshold to maintain the clamping device 502 in the on state. In certain embodiments, the time constant τ₅₁₂ defines how long the clamping device 502 remains on after being triggered by the first PMOS transistor 508 in response to the ESD event.

At step S606, the holding path 504 is activated to overcome the current discharged from the gate discharge path 512 for the clamping device 502. In some implementations, the at least one holding path 504 is connected to the ESD protection circuit 500 in parallel with the clamp triggering path 506. The holding path 504 charges the gate of the clamping device 502 via a holding path signal in order to overcome the current discharged from the triggering path 402. The holding path 504 includes one or more time constant components 514 such as PMOS-RC and/or NMOS-RC inverters that extend the on time of the holding path 504 to an ESD event. For example, the time constant components 514 increase an amount of time between the occurrence of the ESD event and deactivation of the holding path 404 such that an amount of time between the occurrence of the ESD event and deactivation of the clamp triggering path 402 is less than an amount of time between the occurrence of the ESD event and deactivation of the holding path 404. The ESD protection circuit 500 has two time constant components 514 having time constants τ₅₁₄ₐ and τ_{514b}. In some implementations, a sum of the time constants associated with the holding path 504, τ₅₁₄ₐ and τ_{514b}, is greater than a sum of the time constants associated with the clamp triggering path 506, τ₅₁₂ and τ₅₁₀. Therefore, the holding path 504 stays activated even after the triggering path 506 is deactivated, and the holding path 504 charges the gate of the clamping device 502 for a longer amount of time than the clamp triggering path 506 so that the clamping device 502 remains active and provides a path for ground for the current generated by the voltage transient of the ESD event at the voltage rails V_{DD} and V_{SS}.

In some implementations, the holding path 504 can include a second PMOS transistor 516 that shares common source and drain connection points with the first PMOS transistor 508 of the clamp triggering path 506. For example, the source of the second PMOS transistor 516 is connected to the supply voltage V_{DD} and the drain is connected to the gate of the clamping device 502. Therefore, the holding path 504 can charge the gate of the clamping device 502 in order to overcome the current discharged from the gate discharge path 512 so that a total on-time of the clamping device 502 can be increased.

At step S608, the clamping device 502 is turned off after termination of the ESD event. In some implementations, time constants associated with the clamp triggering path 506 and the holding path 504 are designed so that the clamping device 502 remains active for a period of time that is greater than a time length of a worst-case ESD event associated with the device to which the ESD protection circuit 500 is protected. For example, if the ESD protection circuit 500 is being used to provide CESD protection to an ETHERNET PHY, the time constants of the of the holding path 504 and/or clamp triggering path 506 can be designed to maintain the clamping device 502 in an on state for an amount of time that is at least as long as an ESD event that may occur when a charged cable is inserted into an ETHERNET port of a switch or router.

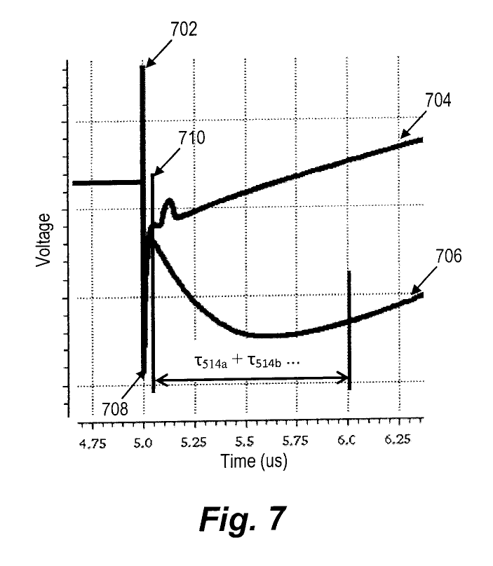

FIG. 7 is an exemplary graph illustrating triggering path and holding path operations of an ESD clamp circuit 500, according to certain embodiments. Curve 704 illustrates supply voltage V_{DD} when only the clamp triggering path 506 is used to respond to the ESD event, and curve 706 illustrates the supply voltage V_{DD} when both the clamp triggering path 506 and the holding path are used. For example, for both curves 704 and 706, voltage spike 702 results when an ESD event has occurred at time 5.0 microseconds (μs), and the clamping device 502 is activated by the clamp triggering path 506, which pulls the supply voltage V_{DD} low, as shown at point 708. When only the clamp triggering path 506 is in effect, the clamping device 502 may be released prior to the termination of the ESD event due to current discharge through the current discharge path 512, which can result in a subsequent voltage increase, as shown by the curve 704. When both the clamp triggering path 506 and the holding path 504 are in effect as shown by the curve 706, the holding path 504 is activated at time 710, which corresponds to a time that is later than the time that the clamp triggering path 506 is activated.

In addition, because the sum of the time constants τ₅₁₄ₐ and τ_{514b} associated with the holding path 504 are greater than the sum of the time constants τ₅₁₂ and τ₅₁₀ associated with the clamp triggering path 506 so that the clamping device 502 on-time can be extended to be at least as long as a worst-case ESD event for the semiconductor device. For example, in the graph of FIG. 7, the sum of τ₅₁₄ₐ and τ_{514b} of the holding path 504 ensures that the clamping device 502 remains active for approximately 1.0 μs after the occurrence of the EST event at 5.0 μs. Because the holding path 504 is activated after the clamp triggering path 506, the amount of on-time of the clamping device 502 is increased, which maintains the supply voltage V_{DD} at a lower value for a longer amount of time than when the clamp triggering device 506 alone is used to activate the clamping device 502.

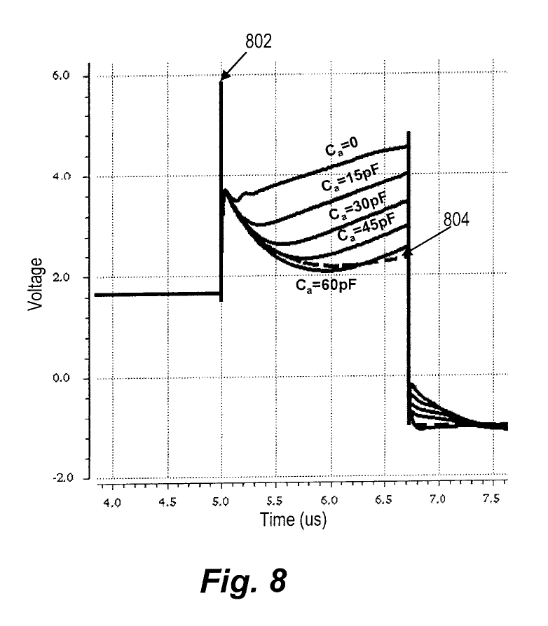

FIG. 8 is an exemplary graph illustrating operating voltages of ESD clamp control circuits, according to certain embodiments. For example, dashed curve 804 represents the supply voltage V_{DD} of the ESD protection circuit 500 having multi-path, multi-time constant ESD protection for an ESD event that causes voltage spike 802. The solid curves represent supply voltage V_{DD} of a conventional ESD protection circuit, such as the ESD protection circuit 200 described previously with respect to FIG. 2 where the capacitance value C₂ is tested at 0 picofarads (pF), 15 pF, 30 pF, 45 pF, and 60 pF. The capacitance value C₂ is increased in order to improve the performance of the ESD protection circuit 200, and the 60 pF capacitance yields results that correspond to the results of the ESD protection circuit 500. For example, the 60 pF capacitance implementation achieves approximately equal amounts of suppression of the voltage transient as the ESD protection circuit 500. However, increasing the C₂ capacitance to 60 pF approximately doubles a circuit pad area due to the increased capacitor size. In addition, when the ESD protection circuit 200 is implemented in GPHY applications, there is an approximately 35% increase in size for one GPHY channel due to the increased capacitor size. In addition, increasing the capacitance value also increases the magnitude of the voltage spike 802 due to an increased amount of capacitor charging that may be required to activate the clamping device in response to the ESD event.

By providing independent, decoupled clamp triggering and passive on-time control, performance of the ESD protection circuit 500 can be improved without drawbacks such as increased circuit area due to increasing capacitor size and/or increasing leakage currents. In addition, circuit complexity of the ESD protection circuit 500 is reduced as compared to the ESD protection circuit 300 described with respect to FIG. 3 and does not have oscillation and deadlock condition issues that result from having a positive feedback loop where the clamping device is activated by a current generated based on the supply voltage V_{DD}. The ESD protection circuit 500 can also be used in other application than CESD, such as in human body model (HBM), charge device model (CDM), and/or machine model (MM) applications. In some implementations, the ESD protection circuit 500 can also be implemented as an on-chip component, and the semiconductor device may not have to rely on off-chip diodes and/or sacrifice driver area to provide ESD protection.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. Additionally, an implementation may be performed on modules or hardware not identical to those described. Accordingly, other implementations are within the scope that may be claimed.

1. A device comprising:
circuitry configured to
detect an occurrence of an electrostatic discharge (ESD) event at one or more voltage rails,
activate an ESD clamp via a clamp triggering path to provide a discharge path for an ESD current, and
maintain a gate voltage of the ESD clamp greater than a predetermined threshold via a holding path in parallel with the clamp triggering path.

2. The device of claim 1, wherein the ESD clamp is a NMOS transistor having a drain connected to a supply voltage rail and a source connected to a ground voltage rail.

3. The device of claim 1, wherein the clamp triggering path includes a high pass filter configured to filter out voltage transients having a rate of change less than a predetermined threshold.

4. The device of claim 1, wherein the clamp triggering path includes a first transistor configured to drive the gate voltage of the ESD clamp high in response to the occurrence of the ESD event.

5. The device of claim 4, wherein the first transistor is a PMOS transistor having a source connected to a supply voltage rail and drain connected to a gate of the ESD clamp.

6. The device of claim 1, wherein the gate voltage of the ESD clamp is discharged via gate discharge current path including a resistor and capacitor connected in parallel.

7. The device of claim 6, wherein the holding path is configured to supply a first current to a gate of the ESD clamp via a second transistor.

8. The device of claim 7, wherein the second transistor is a PMOS transistor having a source connected to a supply voltage rail and drain connected to the gate of the ESD clamp.

9. The device of claim 7, wherein the first current supplied to the gate of the ESD clamp by the holding path is greater than or equal to a second current discharged through the gate discharge current path.

10. The device of claim 1, wherein a first amount of time between the occurrence of the ESD event and a clamp triggering path deactivation is less than a second amount of time between the occurrence of the ESD event and a holding path deactivation.

11. The device of claim 10, wherein the holding path includes one or more time constant components configured to increase the second amount of time between the occurrence of the ESD event and the holding path deactivation.

12. The device of claim 1, wherein a first sum of one or more holding path time constants is greater than a second sum of one or more clamp triggering path time constants.

13. The device of claim 12, wherein the one or more clamp triggering path time constants include at least one of a high pass filter time constant and a gate discharge path time constant.

14. The device of claim 12, wherein the one or more holding path time constants are associated with one or more series-connected time constant components.

15. The device of claim 1, wherein a first width/length ratio of a first PMOS transistor associated with the clamp triggering path is greater than a second width/length ratio of a second PMOS transistor associated with the holding path.

16. The device of claim 15, wherein the second width/length ratio of the second PMOS transistor is 5% to 10% of the first width/length ratio of the first PMOS transistor.

17. The device of claim 1, wherein a first leakage current associated with the clamp triggering path is greater than a second leakage current associated with the holding path.

18. The device of claim 1, wherein the ESD event is a cable ESD event associated with an ETHERNET PHY.

19. A method comprising:
detecting an occurrence of an electrostatic discharge (ESD) event at one or more voltage rails;
activating an ESD clamp via a clamp triggering path to provide a discharge path for an ESD current; and
maintaining a gate voltage of the ESD clamp greater than a predetermined threshold via a holding path in parallel with the clamp triggering path.

20. A device comprising:
circuitry configured to
decouple a triggering signal from an on-time control signal for an ESD clamp response to an occurrence of an ESD event, and
passively control an on-time of the ESD clamp independent of a supply rail voltage.
